(19) United States
(12) Patent Application Publication
(10) Pub. No.: US 2011/0239499 A1
(43) Pub. Date: Oct. 6, 2011

(54) DEVICES FOR PRESENTING SIGNAGE ON A HORNED BOVINE AND METHODS ASSOCIATED THEREWITH

(76) Inventor: Robb E. Shirley, Springville, UT (US)

(21) Appl. No.: 12/897,668

(22) Filed: Oct. 4, 2010

Related U.S. Application Data
(60) Provisional application No. 61/248,467, filed on Oct. 4, 2009.

(51) Int. Cl. A01K 11/00; A01K 29/00

(52) U.S. Cl. 40/300; 119/851

(57) ABSTRACT

A method of using signage on a horned bovine while the bovine is engaged in a display activity is disclosed. The method can include disposing a sleeve on a horn of the bovine, the sleeve having an image disposed on an exterior surface of the sleeve that conveys information to a viewer, and causing the bovine to engage in the display activity. The sleeve can include a tube having a first end with a first diameter and a second end with a second diameter, the first end and the second end being open to allow a tip of a bovine horn to pass through. The tube can fit over at least a portion of the horn and can include an elastic material to cause the tube to contract about the portion of the horn. The tube can be a continuous tubular surface or a sheet formable into the tube.

### PRIORITY DATA

This application claims the benefit of U.S. Provisional Application Ser. No. 61/248,467, filed on Oct. 4, 2009, which is incorporated herein by reference.

### FIELD OF THE INVENTION

The present invention relates generally to signage and associated methods. Accordingly, the present invention involves the mechanical arts and information fields.

### BACKGROUND OF THE INVENTION

Advertisers have long used sporting or other public competitive events as a mechanism to reach potential customers. Certain competitive sports rely on sponsorship to fund their competitive operations. Racing is one common sporting type, for example, where team sponsorship is pervasive. Typically, the sponsor places its logo on a racing vehicle (i.e. a car or a bicycle) and the uniform or suit worn by the vehicle operator. Certain types of sporting events, however, have not been utilized by advertisers to this extent. For example, advertisers have not placed sponsor logos on animals while the animals are engaged in a sporting or other competitive activity. For example, rodeo and bull fighting events have the potential for generating additional revenue from utilizing advertising on the rodeo animals, such as bulls and steers. One hindrance to utilizing animals as advertising space, however, is the impact that the signage may have on the animals during the sporting or competitive activity, which in turn may interfere with the event itself. Thus, the present inventors have discovered a need for signage that is wearable by an animal and that does not substantially hinder the animal's performance or safety during a sporting or competitive activity.

### SUMMARY OF THE INVENTION

Accordingly, the present invention provides methods of using signage on a horned bovine. The present invention also provides a bovine horn sleeve, or signage device, associated with such method. In one aspect, for example, a method of using signage on a horned bovine while the bovine is engaged in a display activity is provided. Such a method may include disposing a sleeve on a horn of the bovine, the sleeve having an image disposed on an exterior surface of the sleeve that conveys information to a viewer. The method may further include causing the bovine to engage in the display or sporting activity.

In one aspect of the present invention, disposing a sleeve on a horn of the bovine may comprise rolling a second end of the sleeve toward a first end of the sleeve, sliding the sleeve over the horn, and unrolling the second end of the sleeve away from the first end of the sleeve.

In another aspect of the present invention, disposing a sleeve on a horn of the bovine may comprise attaching a first edge of the sleeve proximate to a second edge of the sleeve, the first edge being opposite the second edge on a sheet.

In yet another aspect of the present invention, the display activity may be selected from the group consisting of: bull riding, bull fighting, steer wrestling, and steer roping.

In still another aspect of the present invention, the image may be an advertisement.

In an additional aspect of the present invention, the method can further comprise improving safety of the display activity, wherein the sleeve comprises a padding material.

The present invention additionally provides a bovine horn sleeve. The bovine horn sleeve may comprise a tube having a first end with a first diameter and a second end with a second diameter, the first end and the second end being open to allow a tip of a bovine horn to pass through. In some aspects, only one end may be open and the other end closed. Additionally, the tube may be sized to fit over at least a portion of the horn and may include an elastic material to cause the tube to contract about a portion of the horn. In one aspect, the tube may be a continuous tubular surface. In another aspect, the tube may be a sheet formable into a tube.

In some aspects of the present invention, the sheet may be formable into the tube by attaching a first edge of the sheet proximate to a second edge of the sheet, the first edge being opposite the second edge on the sheet. In a specific aspect, the first edge may attach to the second edge by a hook and loop fastener, a snap, or an adhesive.

In one aspect of the present invention, the first diameter may be greater than the second diameter, such that the tube tapers from the first end to the second end. In another aspect, a ratio of the first diameter and the second diameter may be from about 1:1 to about 10:1.

In another aspect of the present invention, the bovine horn sleeve may further comprise a friction enhancing material disposed on an interior of the tube to contact the horn and resist displacement of the sleeve relative to the horn.

In yet another aspect of the present invention, the tube may further comprise a material that is flexible, or at least minimally flexible, to substantially conform to the shape of the horn, or a segment thereof.

In still another aspect of the present invention, the bovine horn sleeve may further comprise an image to convey information to a viewer, the image being disposed on an exterior of the tube. In a specific aspect, the image may be an advertisement. In another specific aspect, the image may be permanently disposed on the exterior of the tube.

The present invention additionally provides a signage system. The signage system may comprise a bovine having a horn and a bovine horn sleeve disposed on the horn. The sleeve may have an image disposed on an exterior surface of the sleeve to convey information to a viewer.

In one aspect of the present invention, the signage system may further comprise a second bovine horn sleeve disposed on a second horn of the bovine. The second sleeve may have an image disposed on an exterior surface of the second sleeve to convey information to the viewer.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a perspective view of a signage system engaged on a horned bovine in accordance with an embodiment of the present invention.

FIG. 2 is a perspective view of a bovine horn sleeve in accordance with an embodiment of the present invention.

FIG. 3 is a top view of a bovine horn sleeve in the form of a sheet in accordance with an embodiment of the present invention.

FIG. 4 is a perspective view of a bovine horn sleeve in accordance with another embodiment of the present invention.

FIG. 5 is a perspective view of a bovine horn sleeve in accordance with yet another embodiment of the present invention.

FIG. 6 is a perspective view of a bovine horn sleeve in accordance with still another embodiment of the present invention.

FIG. 7 is a perspective view of a bovine horn sleeve in accordance with an additional embodiment of the present invention.

FIG. 8 is a schematic of a method of using signage on a horned bovine while the bovine is engaged in a display activity, in accordance with an embodiment of the present invention.

FIG. 9 is a perspective view of a method step of disposing a sleeve on a horn of a bovine in accordance with an embodiment of the present invention.

FIG. 10 is a perspective view of another method step of disposing a sleeve on a horn of a bovine in accordance with an embodiment of the present invention.

FIG. 11 is a perspective view of yet another method step of disposing a sleeve on a horn of a bovine in accordance with an embodiment of the present invention.

### DETAILED DESCRIPTION OF THE INVENTION

Definitions

In describing and claiming the present invention, the following terminology will be used in accordance with the definitions set forth below.

The singular forms “a,” “an,” and, “the” include plural referents unless the context clearly dictates otherwise. Thus, for example, reference to “a sleeve” includes reference to one or more of such boots, and reference to “the attachment” includes reference to one or more of such attachments.

As used herein, the term “about” is used to provide flexibility to a numerical range endpoint by providing that a given value may be “a little above” or “a little below” the endpoint.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The Invention

The present invention relates to signage on a horned bovine. In particular, signage on the bovine can be present while the bovine is engaged in a display activity. Display activities can include nearly any event where the bovine is on display. For example, events where the bovine is physically active, such as rodeo events like bull riding, steer wrestling, and steer roping, as well as events where the bovine is less physically active such as grooming and show competitions at a state fair, auction, etc. In another example, the display activity can be bull fighting. Signage can include text, images, or a combination of text and images. In one aspect, signage can be commercial in nature. In a particular aspect, signage can include advertising material, such as a logo of a company. In another aspect, signage can be purely decorative, with no commercial element or message.

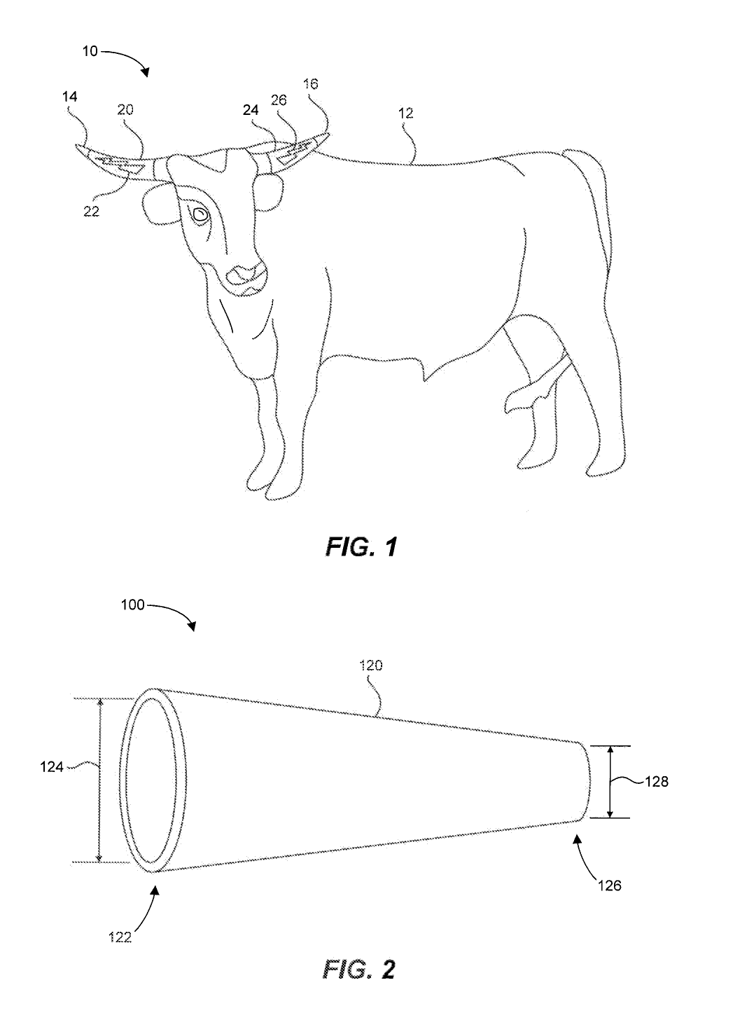

With reference to FIG. 1, illustrated is a perspective view of an embodiment of a signage system 10. The system 10 may include a bovine 12 having a horn 14. The system 10 may also include a bovine horn sleeve 20 disposed on the horn 14. The sleeve 20 may have an image 22 disposed on an exterior surface of the sleeve 20 to convey information to a viewer. The system 10 may further comprise a second bovine horn sleeve 24 disposed on a second horn 16 of the bovine 12. The second sleeve 24 may have an image 26 disposed on an exterior surface of the second sleeve 24 to convey information to the viewer. Thus, one or both horns of the bovine can have a bovine horn sleeve disposed thereon. Although the images 22 and 26 in FIG. 1 are similar, it should be recognized that images 22 and 26 can be the same or different from one another.

Further, it should be recognized that all bovine horns are not equal in size and shape. Thus, the bovine horn sleeve of the present disclosure can be configured to fit bovine horns of any size and shape. For example, longer bovine horns can accommodate longer sleeves. Likewise, large diameter bovine horns may require large diameter sleeves. Additionally, bovine horns may have a large diameter on one end and a small diameter on another end. As will be discussed further below, bovine horn sleeves can be configured to have different diameters at opposite ends of the sleeve to accommodate variations in horn diameter.

It should also be recognized that the sleeve can be configured to fit a curved horn, or a curved segment of a horn. This can be accomplished, for example, by using a sufficiently flexible and elastic material. Accommodating a curved horn can also be accomplished by shaping or patterning the sleeve to fit a curved horn. Although the examples shown in the figures generally illustrate a sleeve that is not significantly shaped or patterned to fit a curved horn, it should be recognized that such an approach can be utilized with the disclosed examples discussed herein.

With reference to, FIG. 2 illustrated is a bovine horn sleeve 100 comprising a tube 120. The tube 120 includes a first end 122 with a first diameter 124 and a second end 126 with a second diameter 128. The first end 122 and the second end 126 may be open to allow a tip of a bovine horn to pass through. Alternatively, the second end 126 may be closed (not shown) in order to encase or cover the tip of the horn. Further, when closed, the second end, 126 may be decorated in a different way than the remainder of the device, or may be of a material that is different from the rest of the device, such as silver tips or caps, and the like. In some regards, such caps may be used as a safety measure to effectively blunt the horns. The tube 120 can be sized to fit over at least a portion of the horn. As indicated above, diameter 124 and diameter 128 can be sized to fit a bovine horn. As shown in FIG. 2, diameter 124 and diameter 128 are different in size. In this case, the diameter 124 is greater than diameter 128. The result is that the tube 120 tapers from the first end 122 to the second end 126. Although not shown, diameter 124 and diameter 128 can be the same size or substantially the same size. For sizing purposes, diameter 124 and diameter 128 can be related to one another by a ratio. For example, where diameter 124 is the same as diameter 128, the ratio of diameter 124 to diameter 128 is 1:1. As a further example, where diameter 124 is ten times greater than diameter 128, the ratio of diameter 124 to diameter 128 is 10:1. In yet another aspect, the size of the opening at the first end as compared to the size of opening at the second end may be a ratio of from about 10:1 to about 1:1. In yet another aspect, the ratio may be from about 6:1 to about 2:1. In a further aspect, the ratio may be from about 4:1 to about 1.5:1. Nearly any ratio can be used to help indicate the size of sleeve needed to fit a given portion of a given horn. With regard to size, in some aspects, the diameter of opening at either end may be from about 14 inches to about 1 inch. In yet another aspect, the diameter of the opening at the first end may be from about 14 inches to about 4 inches and the diameter of the opening at the second end may be from about 8 inches to about 3 inches.

In addition to sizing the sleeve using a diameter ratio, the sleeve can also be sized based on an actual diameter of the bovine horn, such as a diameter corresponding to diameter 124 or diameter 128. In general, a given size of sleeve can be intended to fit a range of horn sizes. Thus, the sleeves can be configured to fit extra small, small, medium, large, or extra large diameter horns. This general sizing designation can be combined with a diameter ratio to create a sizing scheme that can accommodate a variety of horn sizes and shapes. In a specific aspect, the sizing scheme can also include a sleeve length designation. This can be combined with the general sizing designation and the diameter ratio to more closely size a sleeve to fit a given portion of a given horn.

Additionally, the sleeve sizing scheme can include a curvature designation to more closely fit sleeves to horns that curve. In one aspect, curvature designations can be a radius of the curvature of the horn or sleeve. In another aspect, curvature designations can be an inverse of the radius of curvature of the horn or sleeve. In yet another aspect, one length (i.e. side) of the device may be substantially straight between the first and second ends while the other length or side may be curved or angle, thus providing a taper from one end to another.

As mentioned above, the bovine horn sleeve 100 may be constructed of an elastic material. The elastic material has several benefits. The elastic material can allow the tube 120 to expand for fitting the sleeve 100 to the horn, thus allowing the sleeve to fit a range of different sizes, shapes, and/or curvatures of horns. Additionally, once on the horn, the elastic material can cause the tube 120 to contract about the horn. This can aid in maintaining the sleeve on the horn throughout the display activity. Elastic materials can include spandex, neoprene, and materials that include such.

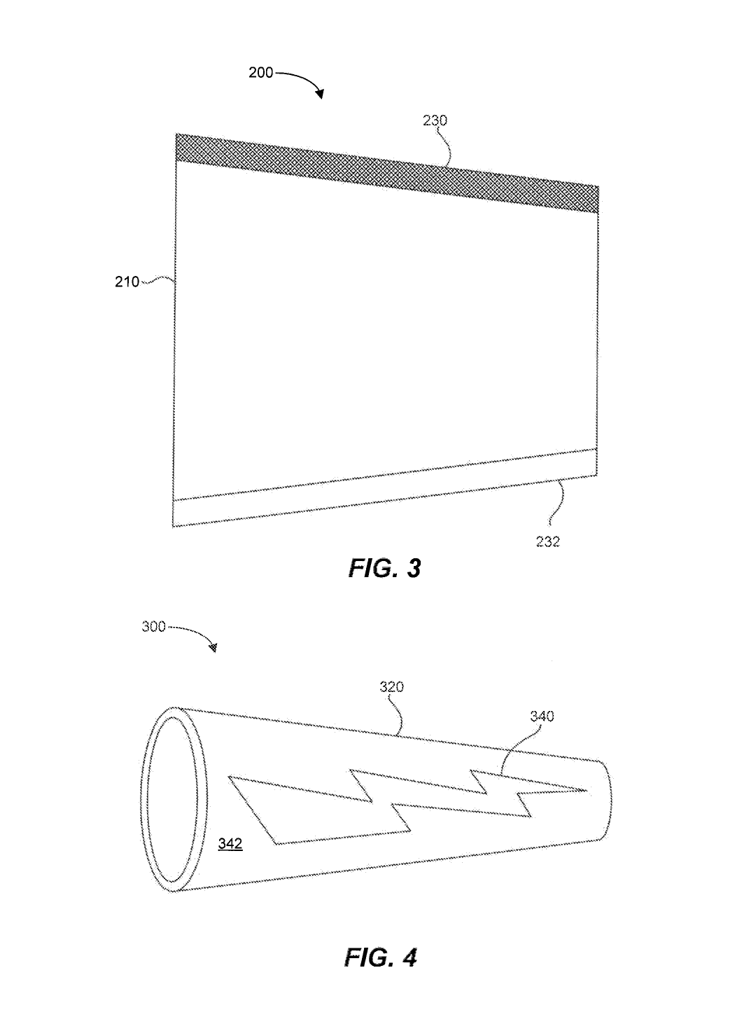

As illustrated in FIG. 2, the tube 120 can be a continuous tubular surface. In other words, the tube 120 is a continuous tubular surface when in a tubular form. The tube 120 can be integrally formed as a continuous tubular surface. In another aspect, as illustrated in FIG. 3, the tube 200 can comprise a sheet 210. The sheet 210 is not in a tubular form and, thus, is not a continuous tubular surface. This distinction between a continuous tubular surface and a sheet can have significance when disposing or fitting the sleeve to the horn, as will be discussed in more detail below.

With further reference to FIG. 3, the sheet 210 is formable into a continuous tubular surface by attaching a first edge 230 of the sheet 210 proximate to a second edge 232 of the sheet 210. As can be seen, the first edge 230 is opposite the second edge 232 on the sheet 210. In some aspects, the sheet 210 can temporarily form a continuous tubular surface, such that the first edge 230 is detachable from the second edge 232. Temporary attachments for the first edge to the second edge can include a hook and loop fastener, a snap, an adhesive, or any other suitable temporary attachment. In other aspects, the sheet 210 can permanently form a continuous tubular surface, such that the first edge 230 is not detachable from the second edge 232. A permanent attachment can utilize sewing, welding, adhesives, rivets, staples, or any other suitable temporary or permanent fastener or fastening technique. A continuous tubular surface can be formed prior to, contemporaneous with, or after the sleeve has been disposed on the horn.

With reference to FIGS. 4-7, illustrated are several embodiments of a bovine horn sleeve. As shown in FIG. 4, the bovine horn sleeve 300 can include an image 340. As discussed above, the image 340 can be commercial or noncommercial in nature. Thus, the image 340 can be configured to convey information to a viewer. The information can be an advertisement, a personal message, etc. Accordingly, the image 340 can be disposed on an exterior 342 of the tube 320 such that the image is visible to the viewer. In one aspect, the image can be permanently disposed on the exterior of the tube. For example, the image can be sublimated, silkscreened, printed, painted, drawn, adhered by an adhesive such as a sticker, etc. In another aspect, the image can be removable from the tube such that a new or different image can be disposed on the tube in its place. For example, the image can be disposed on a separate material and attached to the tube by hook and loop fasteners, snaps, adhesive, or any other nonpermanent fastener. In one aspect, the material can be neoprene and the image can be sublimated onto the neoprene.

In one aspect, the sleeve comprises a single material. This material may be elastic to enable the sleeve to contract about the horn, which can assist the sleeve in remaining on the horn throughout the display activity. In another aspect, as illustrated in FIG. 5, the bovine horn sleeve 400 can include a material 460 that is minimally flexible to substantially conform to the horn. In other words, the sleeve 400 can include a material 460 that is inelastic relative to the elastic material 462 and the material 460 can be at least minimally flexible to allow the sleeve to conform generally to the shape of a tube and to the shape of the horn. Elastic material 462 can be present in an amount and configuration to enable the tube 420 to be contracted about the horn by the elastic material such that the sleeve is maintained on the horn throughout the display activity. Minimally flexible materials 460 can include leather, cotton, polyester, nylon, or any other textile or material that is suitably flexible and relatively inelastic. Alternatively, in some embodiments, multiple flexible materials can be used, for example, neoprene with one or more segments of spandex.

Minimally flexible material 460 and/or elastic material 462 can include a padding material. A padding material can improve safety of the display activity by cushioning the horn or horns of the bovine. In the event that the horn contacts a participant in the display activity, the padding material can soften the impact of the horn. A padding material can include neoprene, cotton, foam, memory foam, polystyrene, natural rubber, synthetic rubber, or any other suitable padding material. In a specific aspect, the sleeve can be closed at the second end, thereby covering the tip of the horn.

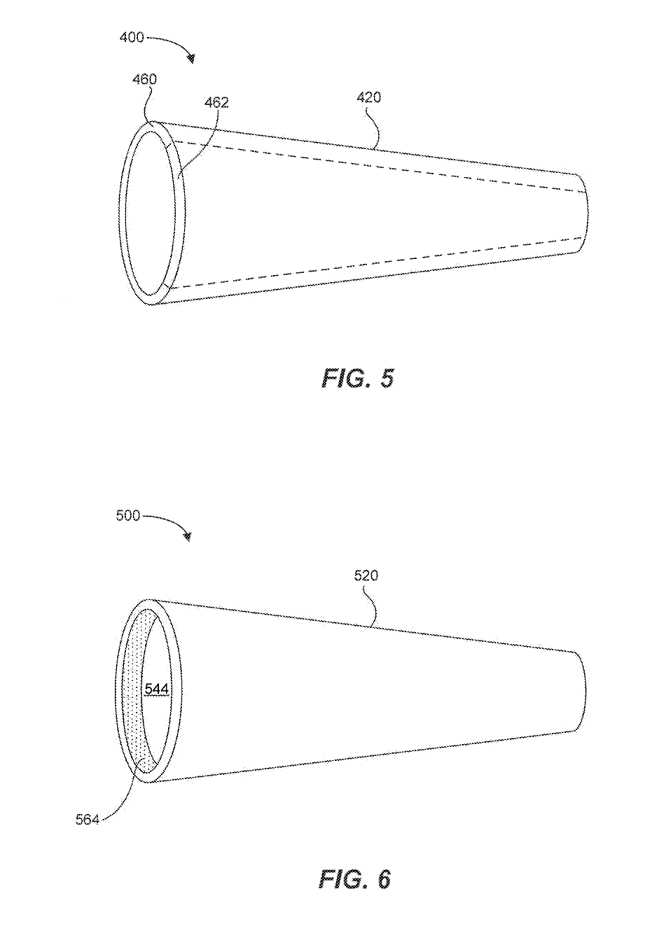

As illustrated in FIG. 6, the bovine horn sleeve 500 can include a friction enhancing material 564 disposed on an interior 544 of the tube 520 to contact the horn and resist displacement of the sleeve 500 relative to the horn. The friction enhancing material 564 is shown disposed at only one end of the sleeve. It should be recognized that the friction enhancing material can be disposed anywhere and in any configuration on the interior 544 of the sleeve, including the entire length of the interior of the sleeve. Friction enhancing materials can include natural and synthetic rubber, and polymers such as polyurethane, silicone, ethylene vinyl acetate, polyvinyl chloride, etc. In addition, the friction enhancing materials can include friction enhancing features such as dimples, bumps, protrusions, recesses, etc. to enhance friction between the sleeve 500 and the horn. Such materials may be present at differing degrees of integration with the flexible or minimally flexible materials and can be provided on the underside of (i.e. side in contact with the bovine horn) in nearly any shape or pattern as required in order to achieve and intended grip or performance effect, including extending along substantially the entire underside.

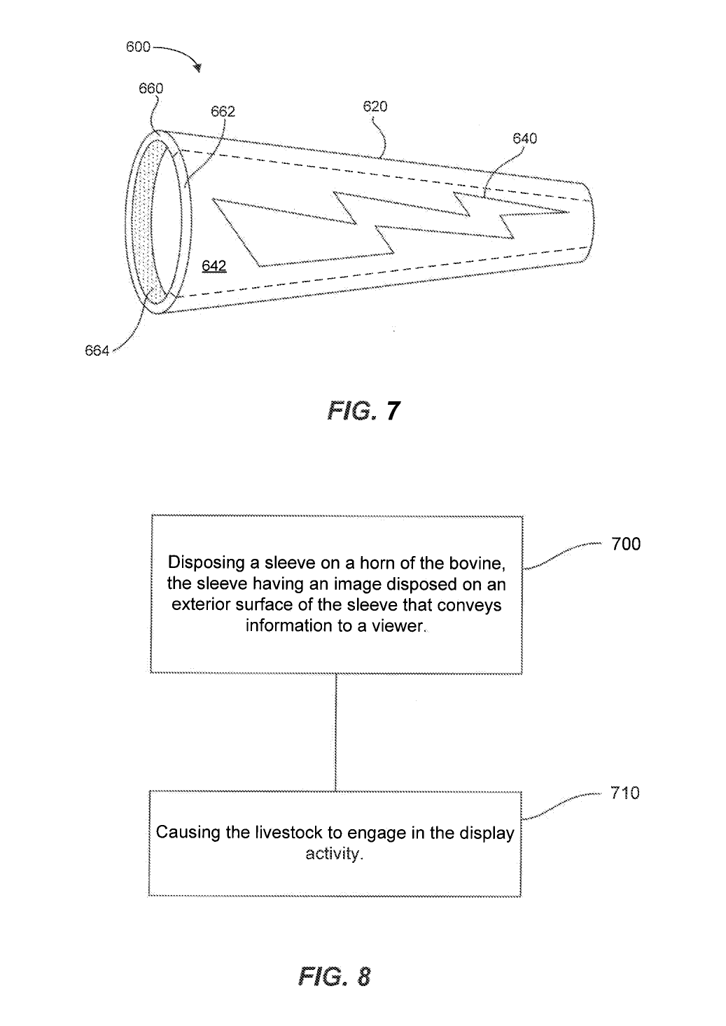

As illustrated in FIG. 7, the bovine horn sleeve 600 can include the various elements shown in FIGS. 4-6 in any combination. For example, sleeve 600 can include an image 640, minimally flexible material 660, elastic material 662, and friction enhancing material 664. As shown, the image 640 is disposed on the elastic material 662. It should be recognized that image 640 can be disposed anywhere on the exterior 642 of the tube 620, including minimally flexible material 660 and elastic material 662, alone or in combination.

In a related embodiment, and to reiterate to some degree, a method of using signage on a horned bovine while the bovine is engaged in a display activity in accordance with the principles herein is shown in FIG. 8. The method can comprise disposing a sleeve on a horn of the bovine, the sleeve having an image disposed on an exterior surface of the sleeve that conveys information to a viewer 700. Additionally, the method can comprise causing the bovine to engage in the display activity 710. It is noted that no specific order is required in this method, though generally in one embodiment, these method steps can be carried out sequentially.

In a specific aspect, the display activity is selected from the group consisting of: bull riding, bull fighting, steer wrestling, and steer roping. In an additional aspect, the method can further comprise improving safety bf the display activity, wherein the sleeve comprises a padding material.

In one aspect of the method, disposing a sleeve on a horn of the bovine can comprise attaching a first edge of the sleeve proximate to a second edge of the sleeve, the first edge being opposite the second edge on a sheet. This may be useful in disposing the sleeve on the horn where the tube comprises a sheet that has not been formed into a tube prior to disposing the sleeve on the horn. In other words, the tube can comprise a sheet that is formed into a tubular shape as the sleeve is disposed on the horn.

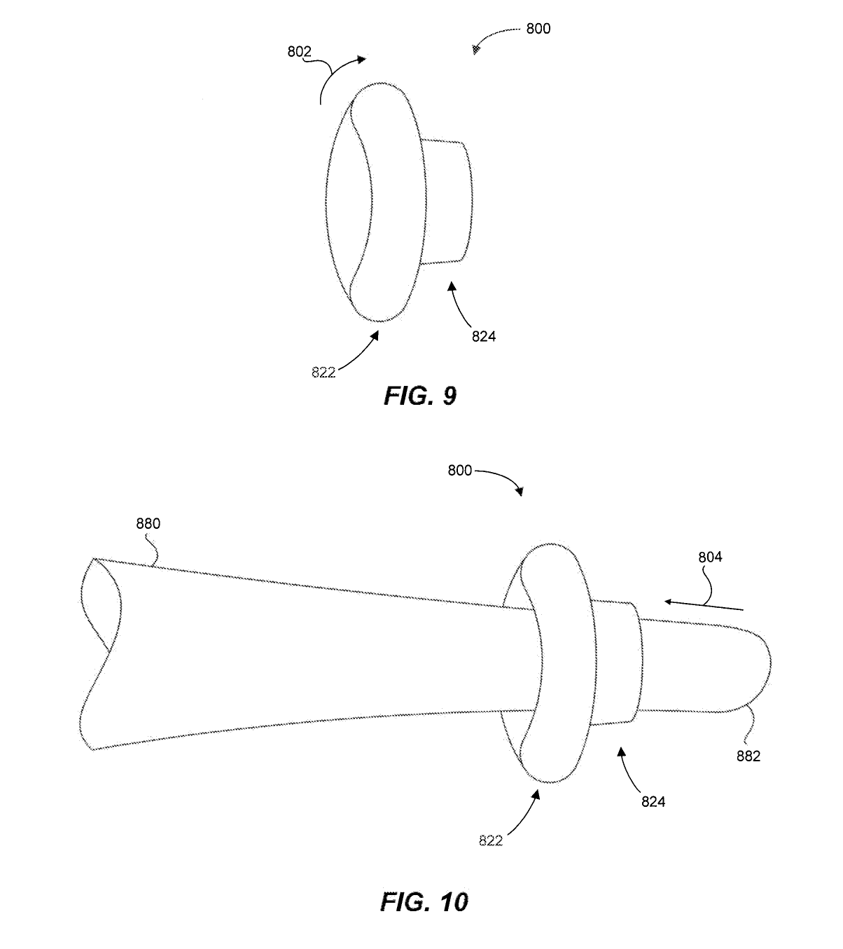

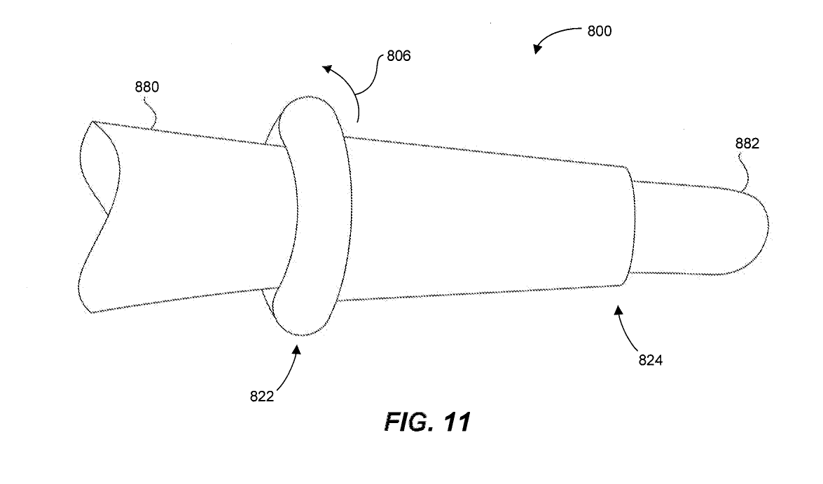

In another aspect of the method, disposing a sleeve on a horn of the bovine can comprise rolling a second end of the sleeve toward a first end of the sleeve, sliding the sleeve over the horn, and unrolling the second end of the sleeve away from the first end of the sleeve. This may be useful in disposing the sleeve on the horn where the tube is a continuous tubular surface prior to disposing the sleeve on the horn. FIGS. 9-11 are provided to illustrate this aspect of disposing a sleeve on a horn of the bovine. FIG. 9 illustrates rolling a first end 822 (i.e. end proximal to the head of the bovine, or “proximal end”) of the sleeve 800 toward a second end 824 (i.e. end distal to the head of the bovine, or “distal end”) of the sleeve 800 in direction 802. FIG. 10 illustrates sliding the sleeve 800 over the horn 880 in direction 804. As shown, the tip 882 of the horn 880 passes through the first end 822 of the sleeve (in this case the larger end) prior to passing through the second end 824 of the sleeve. When the second end 824 is positioned on the horn, FIG. 11 illustrates unrolling the first end 822 of the sleeve away from the second end 824 of the sleeve in direction 806. It should be recognized that the steps illustrated in FIGS. 9-11 can be performed in reverse order to remove the sleeve from the horn.

In yet another aspect of the method, disposing the sleeve on a horn of the bovine, when the tube is in sheet form, or in other words, is not a continuous tubular surface, can comprise disposing the sheet 210 proximate to the horn and attaching the first edge 230 of the sheet proximate to the second edge 232 of the sheet.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of using signage on a horned bovine while the bovine is engaged in a display activity, comprising:
disposing a sleeve on a horn of the bovine, the sleeve having an image disposed on an exterior surface of the sleeve that conveys information to a viewer; and
causing the bovine to engage in the display activity.

2. The method of claim 1, wherein disposing a sleeve on a horn of the bovine comprises:
rolling a first end of the sleeve toward a second end of the sleeve;
sliding the sleeve over the horn; and
unrolling the first end of the sleeve away from the second end of the sleeve.

3. The method of claim 1, wherein disposing a sleeve on a horn of the bovine comprises attaching a first edge of the sleeve proximate to a second edge of the sleeve, the first edge being opposite the second edge on a sheet.

4. The method of claim 1, wherein the display activity is selected from the group consisting of: bull riding, bull fighting, steer wrestling, and steer roping.

5. The method of claim 1, wherein the image is an advertisement.

6. The method of claim 1, further comprising improving safety of the display activity, wherein the sleeve comprises a padding material.

7. A bovine horn sleeve comprising:
a tube having a first end with a first diameter and a second end with a second diameter, the first end and the second end being open to allow a tip of a bovine horn to pass therethrough, the tube being sized to fit over at least a portion of the horn and including an elastic material to cause the tube to contract about the portion of the horn, wherein the tube is a continuous tubular surface or a sheet formable into the tube.

8. The bovine horn sleeve of claim 7, wherein the sheet is formable into the tube by attaching a first edge of the sheet proximate to a second edge of the sheet, the first edge being opposite the second edge on the sheet.

9. The bovine horn sleeve of claim 8, wherein the first edge attaches to the second edge by a hook and loop fastener, a snap, or an adhesive.

10. The bovine horn sleeve of claim 7, wherein the first diameter is greater than the second diameter, such that the tube tapers from the first end to the second end.

11. The bovine horn sleeve of claim 7, wherein a ratio of the first diameter and the second diameter is from about 1:1 to about 6:1.

12. The bovine horn sleeve of claim 7, further comprising a friction enhancing material disposed on an interior of the tube to contact the horn and resist displacement of the sleeve relative to the horn.

13. The bovine horn sleeve of claim 7, wherein the tube further comprises a material that is minimally flexible to substantially conform to the horn.

14. The bovine horn sleeve of claim 7, further comprising an image to convey information to a viewer, the image being disposed on an exterior of the tube.

15. The bovine horn sleeve of claim 14, wherein the image is an advertisement.

16. The bovine horn sleeve of claim 14, wherein the image is permanently disposed on the exterior of the tube.

17. A signage system, comprising:
a bovine having a horn; and
a bovine horn sleeve disposed on the horn, the sleeve having an image disposed on an exterior surface of the sleeve to convey information to a viewer.

18. The signage system of claim 17, further comprising a second bovine horn sleeve disposed on a second horn of the bovine, the second sleeve having an image disposed on an exterior surface of the second sleeve to convey information to the viewer.
